(19) United States
(12) Patent Application Publication
(10) Pub. No.: US 2015/0113532 A1
(43) Pub. Date: Apr. 23, 2015

(54) CLOUDBOOT SYSTEM, VIRTUAL MACHINE WITH THE CLOUDBOOT SYSTEM, AND METHOD FOR STARTING UP THE VIRTUAL MACHINE

(71) Applicant: POWER-ALL NETWORKS LIMITED, Shatin (HK)

(72) Inventors: MENG-MING HUANG, Shenzhen (CN); JUN LV, Shenzhen (CN); YUN-JIE XU, Shenzhen (CN)

(21) Appl. No.: 14/512,601

(22) Filed: Oct. 13, 2014

(30) Foreign Application Priority Data
Oct. 18, 2013 (CN) 201310490170.8

(51) Int. Cl. G06F 9/455; H04L 29/08; G06F 9/445

(52) U.S. Cl. CPC G06F 9/45533; G06F 8/61; H04L 67/10
USPC 718/1

(57) ABSTRACT

A method for starting up a virtual machine (VM) includes: receiving a startup command from a server; determining whether the VM has installed a cloudboot system; obtaining an installation software for installing the cloudboot system and executing the installation software to install the cloudboot system if the VM has not installed a cloudboot system; starting up the cloudboot system to determine a virtual platform supporting the VM, and determine a virtual driver file corresponding to the determined virtual platform, and load the virtual driver file; determining whether there is one guest operating system is stored in the VM; and starting up the guest operating system and causing the VM to enter an operating environment of the guest operating system if there is one guest operating system is stored in the VM.

### CROSS-REFERENCE TO RELATED APPLICATIONS

This application claims priority to Chinese Patent Application No. 201310490170.8 filed on Oct. 18, 2013, the contents of which are incorporated by reference herein. This application is related to the following co-pending, commonly assigned patent applications, the disclosures of which are incorporated herein by reference in their entirety:

1. “INSTALLATION SYSTEM FOR INSTALLING GUEST OPERATING SYSTEM AND METHOD THEREOF” by Huang et al., whose Attorney Docket No is U.S. Pat. No. 542,99.

### FIELD

The present disclosure relates to cloud computing, and particularly to a virtual machine and a method for starting up the virtual machine.

### BACKGROUND

A virtual machine (VM) is a software implementation of a machine that executes programs like a physical machine, such as a server and a personal computer. Usually, the VM is constituted in the physical machine by a corresponding virtual platform and can only be started up by the corresponding virtual platform. For example, a virtual machine constituted by a XEN platform can only be started up via the XEN platform (an open source enterprise-ready server virtualization and cloud computing platform), and cannot be started up via other virtual platforms, such as a Kernel-based Virtual Machine (KVM) platform.

### BRIEF DESCRIPTION OF THE DRAWINGS

Implementations of the present technology will now be described, by way of example only, with reference to the attached figures.

FIG. 1 is a block diagram of a virtual machine.

FIG. 2 is a flowchart diagram of an embodiment of a method for starting up the virtual machine of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

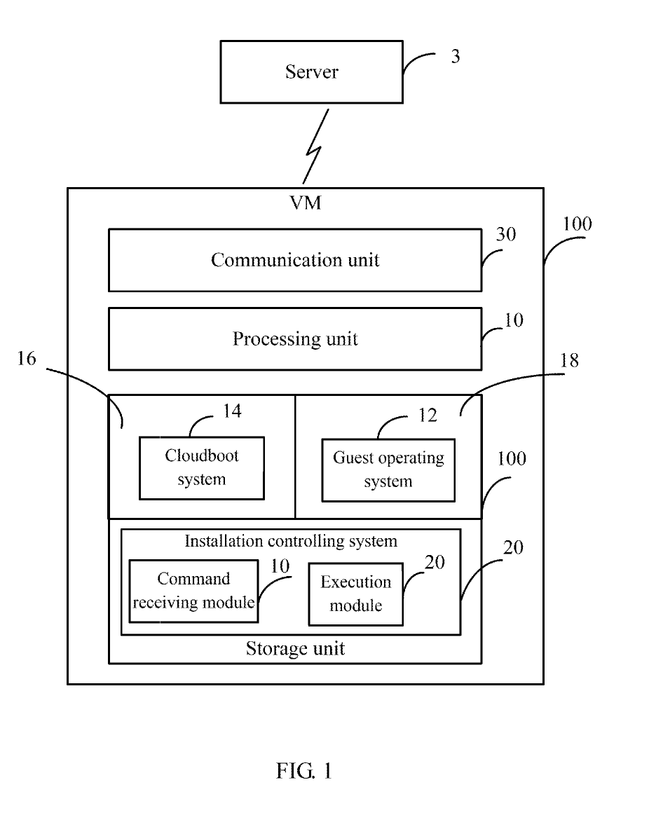

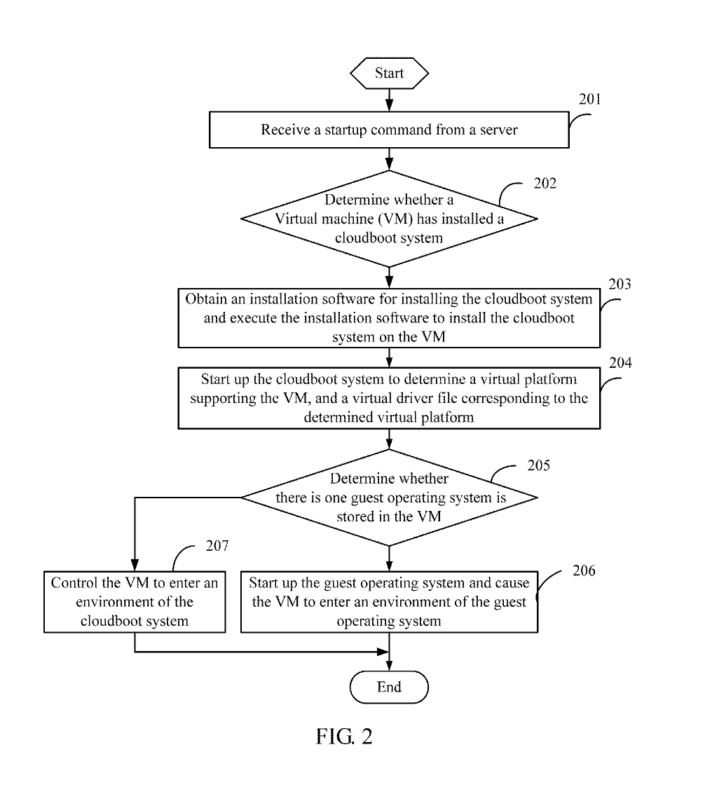

Referring to FIGS. 1 and 2, a VM 100 is illustrated. The VM 100 can be constituted based on any virtual platform, such as a XEN platform, a KVM platform, and the like.

In at least one embodiment, the VM 100 includes a processing unit 10, a storage unit 20, and a communication module 30. The storage unit 20 can store a guest operating system 12 and a cloudboot system 14. The guest operating system 12 can be a WINDOWS® operating system, a LINUX® operating system, and the like. The cloudboot system 14 can be collections of software instructions stored in the storage unit 20 and executed by the processing unit 10.

In at least one embodiment, the VM 100 is constituted in a computing device (not shown), such as a server, a personal computer, and the like. The storage unit 20 can be a storage space assigned from a storage device, such as a hard disk, of the computing device. The processing unit 20 can be one of processing chips, such as one of centre processing units of the computing device.

In at least one embodiment, the cloudboot system 14 is compatible with a number of virtual platforms. The cloudboot system 14 includes various virtual driver files respectively corresponding to various virtual platforms. If the VM 100 already have stored and installed the cloudboot system 14, when the VM 100 is started up, the cloudboot system 14 is run firstly. When the cloudboot system 14 is running, the cloudboot system 14 determines a virtual platform which can support the VM 100, and determines a virtual driver file corresponding to the determined virtual platform, and then starts up the guest operating system 12 stored in the storage unit 20 according to the determined virtual driver file. In at least one embodiment, the cloudboot system 14 first loads the virtual driver file, and starts up the guest operating system according to the loaded the virtual driver file. Therefore, utilizing the cloudboot system 14 of the present disclosure, the VM 100 can be started up by another virtual platform by using the corresponding virtual driver file.

In at least one embodiment, an installation controlling system 2 is stored in the storage unit 20 and executed by the processing unit 10. The installation controlling system 2 includes a command receiving module 21 and an execution module 22. The modules of the installation controlling system 2 can be a collection of software instructions stored in the storage unit 20 and executed by the processing unit 10.

The command receiving module 21 is used to receive a command from a server 3.

When the command received by the command receiving module 21 is a startup command, the execution module 22 starts up the cloudboot system 14.

In detail, the execution module 22 determines whether the VM 100 has installed the cloudboot system 14. If the VM 100 has installed the cloudboot system 14, the execution module 22 starts up the cloudboot system 14 and the cloudboot system 14 controls to start up the guest operating system 12 as described above.

If the VM 100 has not installed the cloudboot system 14, the execution module 22 obtains an installation software for installing the cloudboot system 14, and executes the installation software to install the cloudboot system 14 on the VM 100. In detail, the execution module 22 executes the installation software to cause the installation software to do following steps: dividing the storage unit 20 of the VM 100 into at least a first partition 16 and a second partition 18 and installing the cloudboot system 14 on the first partition 16 of the VM 100. The installation software can be an image file of the cloudboot system 14 and can be obtained from the server 3 by the execution module 22.

The execution module 2 then starts up the cloudboot system 14 after the cloudboot system 14 has been installed in the first partition 16 of the VM 100.

As described above, when the cloudboot system 14 is running, the cloudboot system 14 determines the virtual platform which can support the VM 100, and determines the virtual driver file corresponding to the determined virtual platform.

The cloudboot system 14 further determines whether there is a guest operating system 12 is stored in the VM 100, if yes, the cloudboot system 14 controls to start up the guest operating system 12 and cause the VM 100 to enter an operating environment of the guest operating system 12. If not, the cloudboot system 14 controls the VM 100 to enter an operating environment of the cloudboot system 14. The cloudboot system 14 can be a boot program based on a DOC® operating system. The cloudboot system 14 also can be the program based on the LINUX® operating system.

In at least one embodiment, when the command receiving module 21 receives a download command or an update command, the cloudboot system 14 downloads an installation file of a corresponding guest operating system 12 from the server 3 and installs the corresponding guest operating system 12 on the second partition 18 of the VM 100 by executing the installation file. In at least one embodiment, the command receiving module 21 may receive the download command or the update command while receiving the startup command or after receiving the startup command. In at least one embodiment, a user can log in a user interface (not shown) provided by the server 3 to select or input the corresponding command, for example, starting up the VM 100, downloading the guest operating system 12, updating the guest operating system 12, and the like.

The VM 100 can communicate with the server 3 via the communication module 30. In at least one embodiment, the communication module 30 can be a program stored in the storage unit 20. For example, the communication module 30 can be a remote procedure call (RPC) box, which functions as an email program. The command receiving module 21 can receive the commands from a server 3 via the communication module 30. In other embodiments, the communication module 30 also can be a hardware chip set in the computing device including the VM 100. For example, the communication module 30 can be a telecom card, the 3rd generation telecommunication card.

In at least one embodiment, a size of the first partition 16 can be 200 megabits. In at least one embodiment, the installation controlling system 2 can be stored in other storage spaces of the storage unit 20 beyond the first partition 16 and the second partition 18 as shown in FIG. 1. In another embodiment, the installation controlling system 2 can be stored in any one of the first partition 16 and the second partition 18. The server 3 can be a single server or a server group.

FIG. 2 illustrates a flowchart of a method for starting up a VM. The method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Additionally, the illustrated order of blocks is by example only and the order of the blocks can be changed. The example method can begin at block 201.

In block 201, a command receiving module of a VM receives a startup command from a server.

In block 202, an execution module determines whether the VM has installed a cloudboot system. If yes, the process jumps to block 204, if not, the process jumps to block 203.

In block 203, the execution module obtains an installation software for installing the cloudboot system, and executes the installation software to install the cloudboot system. In detail, the execution module executes the installation software to cause the installation software to divide a storage unit of the VM into at least a first partition and a second partition; and install the cloudboot system on the first partition.

In block 204, the execution module starts up the cloudboot system. In detail, when the cloudboot system is running, the cloudboot system determines the virtual platform supporting the VM, and determines the virtual driver file corresponding to the determined virtual platform, and loads the virtual driver file.

In block 205, the cloudboot system determines whether there is a guest operating system is stored in the VM. If yes, the process jumps to block 206, if not, the process jumps to block 207.

In block 206, the cloudboot system controls to start up the guest operating system according to the loaded virtual driver file and cause the VM to enter an operating environment of the guest operating system.

In block 207, the cloudboot system controls the VM to enter an operating environment of the cloudboot system.

The method can further include: when the command receiving module receives a download command or a update command, the cloudboot system downloads an installation file of a corresponding guest operating system from the server and installs the corresponding guest operating system on the second partition of the VM by executing the installation file.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A cloudboot system comprising a plurality of software instructions stored in a storage unit of a virtual machine (VM) and executed by a processing unit of the VM, and various virtual driver files respectively corresponding to various virtual platforms, when the cloudboot system is started up, the cloudboot system causes the processing unit to:
determine a virtual platform supporting the VM;
determine one of the virtual driver files corresponding to the virtual platform; and
start up a guest operating system stored in the storage unit according to the virtual driver file.

2. The cloudboot system according to claim 1, wherein cloudboot system is started up upon the VM receives a startup command from a server.

3. The cloudboot system according to claim 2, wherein the cloudboot system further causes the processing unit to download an installation file of a corresponding guest operating system from the server and installs the corresponding guest operating system on the VM by executing the installation file when the VM receives a download command or an update command.

4. The cloudboot system according to claim 3, wherein the cloudboot system further causes the processing unit to determine whether there is one guest operating system stored in the VM, and control to start up the guest operating system and cause the VM to enter an operating environment of the guest operating system if there is one guest operating system stored in the VM, and control the VM to enter an operating environment of the cloudboot system if none guest operating system is stored in the VM.

5. A virtual machine (VM) with a cloud boot system comprising:
at least one processing unit; and
a storage unit storing a cloudboot system comprising various virtual driver files respectively corresponding to various virtual platform and a plurality of software instructions that, when executed by the at least one processor, causes the at least one processing unit to:
determine a virtual platform supporting the VM;
determine the virtual driver file corresponding to the determined virtual platform; and
start up a guest operating system stored in the storage unit according to the determined virtual driver file.

6. The virtual machine according to claim 5, wherein the storage device further stores a plurality of modules which are collections of instructions, the at least one processing unit is further configured to execute the plurality of modules which are collections of instructions, the modules comprising:
a command receiving module configured to receive a command from a server; and
an execution module configured to start up the cloudboot system and cause the cloudboot system being executed by the processing unit, when the command is a startup command.

7. The virtual machine according to claim 6, wherein the execution module determines whether the VM has installed the cloudboot system, if the VM has installed the cloudboot system, the execution module starts up the cloudboot system; if the VM has not installed the cloudboot system, the execution module obtains an installation software for installing the cloudboot system, and executes the installation software to install the cloudboot system on the VM, and then starts up the installed cloudboot.

8. The virtual machine according to claim 7, wherein the execution module executes the installation software to cause the installation software to divide the storage unit of the VM into at least a first partition and a second partition; and install the cloudboot system on the first partition.

9. The virtual machine according to claim 6, wherein when being executed by the at least one processor, the cloudboot system further causes the at least one processing unit to download an installation file of a corresponding guest operating system from the server and install the corresponding guest operating system on the VM by executing the installation file when the command receiving module receives a download command or a update command from the server.

10. The virtual machine according to claim 5, wherein when being executed by the at least one processor, the cloudboot system further causes the processing unit to:
determine whether there is one guest operating system stored in the VM;
control to start up the guest operating system according to the loaded virtual driver file and cause the VM to enter an operating environment of the guest operating system if there is one guest operating system stored in the VM; and
control the VM to enter an operating environment of the cloudboot system if none guest operating system is stored in the VM.

11. A method for starting up a virtual machine (VM) comprising:
receiving a startup command from a server;
determining whether the VM has installed a cloudboot system;
obtaining an installation software for installing the cloudboot system and executing the installation software to install the cloudboot system if the VM has not installed a cloudboot system;
starting up the cloudboot system to determine a virtual platform supporting the VM, and determine a virtual driver file corresponding to the determined virtual platform according to various virtual driver files respectively corresponding to various virtual platform comprised in the cloudboot system, and load the virtual driver file;
determining whether there is one guest operating system is stored in the VM; and
starting up the guest operating system and causing the VM to enter an operating environment of the guest operating system if there is one guest operating system is stored in the VM.

12. The method according to claim 11, wherein the step of executing the installation software to install the cloudboot system comprising:
dividing the storage unit of the VM into at least a first partition and a second partition; and
installing the cloudboot system on the first partition of the VM.

13. The method according to claim 12, further comprising:
downloading an installation file of a corresponding guest operating system from the server and installing the corresponding guest operating system on the VM by executing the installation file when receiving a download command or a update command from the server.

14. The method according to claim 11, further comprising:
controlling the VM to enter an operating environment of the cloudboot system if there is none guest operating system is stored in the VM.
